(19) United States
(12) Patent Application Publication
(10) Pub. No.: US 2016/0292234 A1
(43) Pub. Date: Oct. 6, 2016

(54) METHOD AND SYSTEM FOR SEARCHING IN A DISTRIBUTED DATABASE

(71) Applicant: Infosys limited, Bangalore (IN)

(72) Inventor: Sahabaz Kathewadi, Dharwad (IN)

(21) Appl. No.: 14/984,885

(22) Filed: Dec. 30, 2015

(30) Foreign Application Priority Data
Dec. 12, 2014 (IN) 6286/CHE/2014

(51) Int. Cl. G06F 17/30

(52) U.S. Cl. CPC G06F 17/30554; G06F 17/30477; G06F 17/30327

(57) ABSTRACT

A method and a system for searching in a distributed database through modified binary search. The method involves loading (202) one or more index values from a binary tree stored in the distributed database to a cache memory. A relative difference between one index value and another index value is calculated (204). A relative ratio of one relative difference and another relative difference is calculated (206) and an average value of the one or more relative differences is determined (208). The determined average value is corrected (210) based on a correction factor. The corrected average value is assigned (212) to an initial search index of binary search algorithm. A search element in the one or more index values loaded to the cache memory is searched (214) to obtain one or more addresses associated with the searched index value.

This application claims the benefit of Indian Patent Application Serial No. 6286/CHE/2014 filed Dec. 12, 2014, which is hereby incorporated by reference in its entirety.

### FIELD

The present disclosure generally relates to systems and/or methods of increased efficiency in searching large distributed databases and in particular, to a system and/or method to search through index values in a binary tree.

### BACKGROUND

Evolution of database is marked and measured with most important yardstick of speed. Faster an element can be searched in the database, better is performance. As the evolution progressed, various techniques in conjunction with mathematics and algorithm design have been developed and applied on the database to increase the speed of search.

An index in a database may perform same operation as an index of a textbook. Index may hold an address of each element stored in a database. If a table in the database is indexed for elements present in the table, the database may have a copy of the elements registered in the index associated with respective address of the element stored in the database.

Database uses different types of index, depending on pattern of data. B-Tree (Binary Tree) index of one of the types of index. The B-Tree index may enable rapid search of data in the table, if index is created on a column having high cardinality. The index may consist of two parts, branch block and leaf block. The branch block may hold range of intervals of data. More than one branch block may exist. The branch block may be connected to another branch node or a leaf block, depending on level of the B-Tree Index. The leaf block may hold the actual data with the respective address in the database.

A standard binary search algorithm makes it difficult to extract data in a real time scenario due to mandatory number of iterations that would be necessary.

### SUMMARY

Disclosed are a method and a system for searching in a distributed databases through modified binary search.

In one aspect, a computer implemented method involves loading index value(s) from a binary tree to cache memory. A relative difference(s) between the index value(s) and another index value is calculated. A relative ratio of the relative difference(s) and another relative difference is calculated and an average value of the relative difference(s) is determined. The calculated average value is corrected based on a correction factor. The corrected average value is assigned to an initial search index of binary search algorithm. A search element in the index value(s) loaded to the cache memory is searched to obtain address associated with the searched index value.

In another aspect, a system for searching in a binary tree of a distributed database through modified binary search is disclosed. The system includes, a load engine, a calculator, a determination engine, a correction engine, an assignment engine, and a search engine. The load engine is configured to load index value(s) from a binary tree to a cache memory. The calculator is configured to calculate relative difference(s) between the index value(s) and another index value. The calculator is further configured to calculate a relative ratio of the relative difference(s) and another relative difference. The determination engine is configured to determine an average value of the relative difference(s). The correction engine is configured to correct the average value. The assignment engine is configured to assign the corrected average value to an initial search index of binary search algorithm. The search engine is configured to search a search element in the index value(s) loaded to the cache memory to obtain address associated with the searched index value.

In an additional aspect, a computer implemented method for searching in a binary tree of a distributed database through modified binary search is disclosed. The method involves loading index value(s) from a binary tree to cache memory. A relative difference(s) between the index value(s) and another index value is calculated. A relative ratio of the relative difference(s) and another relative difference is calculated and an average value of the relative difference(s) is determined. The calculated average value is corrected based on a correction factor. The corrected average value is assigned to an initial search index of binary search algorithm. A range of binary search in the index value(s) is defined by calculating difference between position of an element in the index value(s) and an approximate position of the element. A search element in the index value(s) loaded to the cache memory is searched to obtain address associated with the searched index value.

### BRIEF DESCRIPTION OF THE DRAWINGS

Example embodiments are illustrated by way of example and not limitation in the figures of the accompanying drawings, in which like references indicate similar elements and in which:

FIG. 1 is a diagrammatic representation of a data processing system capable of processing a set of instructions to perform any one or more of the methodologies herein, according to one embodiment.

FIG. 2 is a process flow diagram, illustrating a method for searching in a binary tree through modified binary search, according to one or more embodiments.

FIG. 3 is a block diagram, illustrating a system for searching in a binary tree through modified binary search, according to one or more embodiments.

FIG. 4 is a process flow diagram, illustrating a method for searching in a binary tree through modified binary search based on range of index values, according to one or more embodiments.

FIG. 5 is a flow chart searching in a binary tree through modified binary search, according to one or more embodiments.

Other features of the present embodiments will be apparent from the accompanying drawings and from the detailed description that follows.

### DETAILED DESCRIPTION

Example embodiments, as described below, may be used to provide a method and/or a system for searching in a distributed database. Although the present embodiments have been described with reference to specific example embodiments, it will be evident that various modifications and changes may be made to these embodiments without departing from the broader spirit and scope of the various embodiments.

Consider a list of hundred (100) names, arranged in alphabetical order. It is easy to search a name in the list, since size of the list is small, and the search can be performed manually. If the list contains a billon names, a computer system can perform search quickly than humans. Presently, data and information being continuously stored all over the world is huge and in next few years, the data and information is expected to explode. Searching in huge data may become cumbersome and impossible to perform manually.

Binary search algorithm is a widely used search technique to search large sets of data. Sets of data may be largely classified into two types namely, static and dynamic. Static data may have data records that are constant. Dynamic data may have data records that are increasing in number and varying in constitution.

In case of dynamic data, size of lists and/or the constituents of the lists may be continuously evolving. For example, a list of all people in a town along with the people's details such as address, social security number and so on. Further, the list may change based on obituaries, new child births, people leaving town and so on. Searching in an ever changing list requires a form of order. In one or more embodiments, the order may be an ascending or descending order.

In an example embodiment, when a list may be searched using binary search algorithm. A list of sorted data may be divided into two sub-lists based on a mid-value. The mid-value may be compared to a name being searched. If the mid-value is not the name being searched then a decision is made to choose one of the two sub-lists to further search. The decision may depend on which side of the mid-value the search term lies in the list's order. The binary search algorithm may be iterated till the name being searched is found i.e. matches with the mid-value of the list. Multiple iterations of searching using the binary search algorithm may become difficult and time consuming.

In one or more embodiments, data needs to be sequentially stored in a database for easy access. In another way of storing data, one or more index values of the data may be stored sequentially in the database for easy access of the data. If new data is added frequently, then size of the data in the database increases and searching becomes difficult with the binary search algorithm. If a size of the data increases, the number of iterations may also increase, based on the location of required data. As a result, time taken to fetch the data from the database may increase significantly.

The present disclosure finds a solution in reducing the number of iterations required to search the data in the database by modifying the binary search algorithm with respect to search in large databases. A method and/or a system for searching in a binary tree through modified binary search, improvises the efficiency of exiting binary search by approximating the initial search position and defining the range of search. Thereby, reducing span of search and reaching at the position of the required data at a faster rate compared to existing binary search algorithm. The method and/or system may considerably reduce the number of iterations of the binary search algorithm, nearly to fifty (50) percent of the number of iterations of the existing binary search algorithm.

A distributed database may be a database with storage devices. The storage devices may not be attached to a common processing unit. A distributed database management system may control the storage devices. Data may be stored in multiple computers, located in a common physical location and/or may be dispersed over a network of interconnected computers. A distributed database system may consist of loosely-coupled sites that share no physical components.

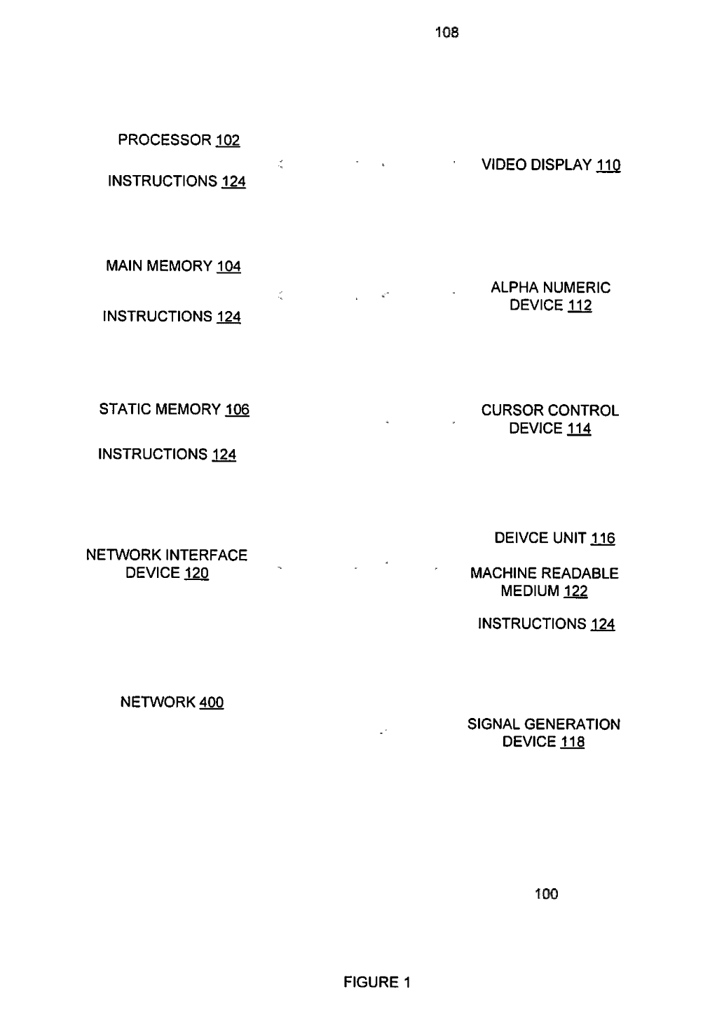

FIG. 1 is a diagrammatic representation of a data processing system capable of processing a set of instructions to perform any one or more of the methodologies herein, according to one embodiment. FIG. 1 shows a diagrammatic representation of machine in the example form of a computer system 100 within which a set of instructions, for causing the machine to perform any one or more of the methodologies discussed herein, may be executed. In various embodiments, the machine operates as a standalone device and/or may be connected (e.g., networked) to other machines.

In a networked deployment, the machine may operate in the capacity of a server and/or a client machine in server-client network environment, and/or as a peer machine in a peer-to-peer (or distributed) network environment. The machine may be a personal—computer (PC), a tablet PC, a set-top box (STB), a Personal Digital Assistant (PDA), a cellular telephone, a web appliance, a network router, switch and/or bridge, an embedded system and/or any machine capable of executing a set of instructions (sequential and/or otherwise) that specify actions to be taken by that machine. Further, while only a single machine is illustrated, the term “machine” shall also be taken to include any collection of machines that individually and/or jointly execute a set (or multiple sets) of instructions to perform any one and/or more of the methodologies discussed herein.

The example computer system 100 includes a processor 102 (e.g., a central processing unit (CPU) a graphics processing unit (GPU) and/or both), a main memory 104 and a static memory 106, which communicate with each other via a bus 108. The computer system 100 may further include a video display unit 110 (e.g., a liquid crystal displays (LCD) and/or a cathode ray tube (CRT)). The computer system 100 also includes an alphanumeric input device 112 (e.g., a keyboard), a cursor control device 114 (e.g., a mouse), a disk drive unit 116, a signal generation device 118 (e.g., a speaker) and a network interface device 120.

The disk drive unit 116 includes a machine-readable medium 122 on which is stored one or more sets of instructions 124 (e.g., software) embodying any one or more of the methodologies and/or functions described herein. The instructions 124 may also reside, completely and/or at least partially, within the main memory 104 and/or within the processor 102 during execution thereof by the computer system 100, the main memory 104 and the processor 102 also constituting machine-readable media.

The instructions 124 may further be transmitted and/or received over a network 400 via the network interface device 120. While the machine-readable medium 122 is shown in an example embodiment to be a single medium, the term “machine-readable medium” should be taken to include a single medium and/or multiple media (e.g., a centralized and/or distributed database, and/or associated caches and servers) that store the one or more sets of instructions. The term “machine-readable medium” shall also be taken to include any medium that is capable of storing, encoding and/or carrying a set of instructions for execution by the machine and that cause the machine to perform any one or more of the methodologies of the various embodiments. The term “machine-readable medium” shall accordingly be taken to include, but not be limited to, solid-state memories, optical and magnetic media, and carrier wave signals.

Exemplary embodiments of the present disclosure provide a system and method for searching in a binary tree of a distributed databases through modified binary search. The system and/or method for searching in a binary tree through modified binary search may involve loading index value(s) from a binary tree to cache memory. A relative difference(s) between the index value(s) and another index value may be calculated. A relative ratio(s) of the relative difference(s) and another relative difference may be calculated and an average value of the relative difference(s) may be determined. The calculated average value may be corrected based on a correction factor. The corrected average value may be assigned to an initial search index of binary search algorithm. A search element in the index value(s) loaded to the cache memory may be searched to obtain address associated with the searched index value.

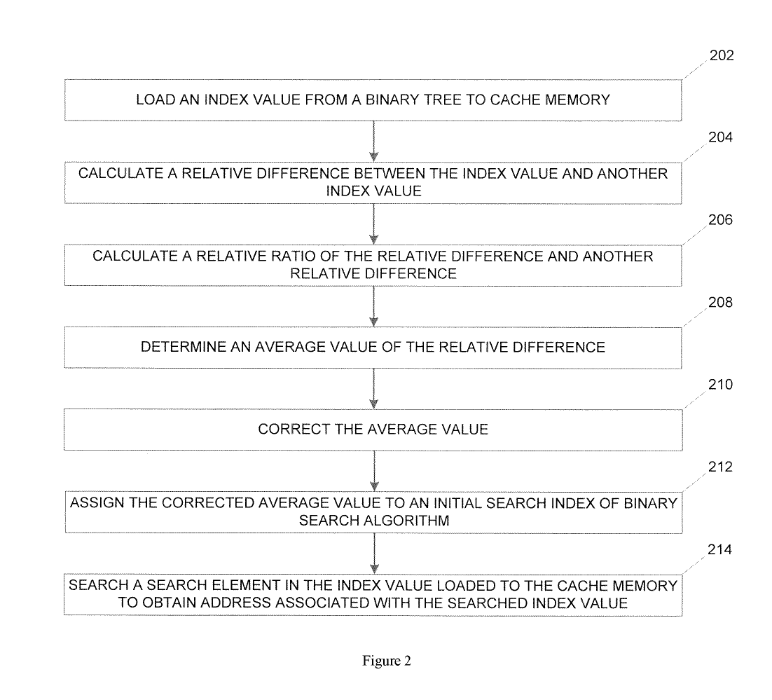

FIG. 2 is a process flow diagram, illustrating a method for searching in a binary tree through modified binary search, according to one or more embodiments. The method includes loading, index value(s) from a binary tree to a cache memory, as in step 202. The index value(s) may be associated with order property and/or approximate relative position property. The index value(s) may have order property if an element in a set of the index value(s) is greater than a preceding element and lesser than a succeeding element. The approximate relative position property may be a relative position assigned an element of the index value(s). The approximate relative position property may be with reference to neighbor element(s) in a sorted sequence of the index value(s). For example, consider a sequence 1, 2 and 3. Element 2 of the sequence may occur at second position with respect to 1 and 3. The element 2 is greater than one 1 and lesser than 3, then the element 2 will the order property. Similarly, element 3 of the sequence may occur at third position. A relative difference(s) between the index value(s) may be calculated, as in step 204. The relative difference(s) may be calculated by applying formulae in Table 1.

TABLE 1

| n | Sequence | d |
|---|---|---|
| 1 | M(1) | not applicable (N/A) |
| 2 | M(2) | ${d}_{1} = \frac{M ( 2 ) - M ( 1 )}{2 - 1}$ |
| 3 | M(3) | ${d}_{2} = \frac{M ( 3 ) - M ( 1 )}{3 - 1}$ |
| . . . | . . . | . . . |
| n | M(n) | ${d}_{n} = \frac{M ( n ) - M ( 1 )}{n - 1}$ |

TABLE 2

| n | η | δ |
|---|---|---|
| n₁ = 1 | ${η}_{1} = \frac{M ( 1 ) - M ( 1 )}{D} + 1$ | δ₁ = n₁ − η₁ |
| n₂ = 2 | ${η}_{2} = \frac{M ( 2 ) - M ( 1 )}{D} + 1$ | δ₂ = n₂ − η₂ |
| . . . | . . . | . . . |
| nₙ = n | ${η}_{n} = \frac{M ( n ) - M ( 1 )}{D} + 1$ | δₙ = nₙ − ηₙ |

where,
n is position of the index value(s);
ηₙ is approximate position of the index value(s); and
δₙ is difference between the position of the index value(s) and the approximate position of the index value(s).

Consider n to be position of index value(s) loaded to the cache memory. Consider d to be the relative difference(s). The relative difference(s) may be calculated for element(s) of the index value(s) by applying a formula:

$${d}_{n - 1} = \frac{M ( n ) - M ( 1 )}{n - 1}$$

where,
n is the position of the index value(s) loaded to the cache memory;
M(n) is an element in the index value(s) at the nth position;
M(1) is an initial element in the index value(s); and
dₙ₋₁ is the relative difference(s) of n^{th} element in the index value(s).
A relative ratio(s) of the relative difference(s) may be calculated, as in step 206. The relative ratio(s) r may be calculated by applying a formula:

$${r}_{n - 2} = ( \frac{{d}_{n - 1}}{{d}_{n - 2}} ) \times 100$$

where,
rₙ₋₂ is the relative ratio of the relative difference(s); and
dₙ₋₁ and dₙ₋₂ are the relative difference(s) of n−1^{th} and n−2^{th} and element of the index value(s) respectively.

In an example embodiment, M(n) is an element in the index value at the n^{th} position. In another example embodiment, M(n) may be an element to be searched in the index value(s).

An average value of the relative difference(s) may be determined, as in step 208. The average value of the relative difference(s) may be determined if value(s) of at least eighty (80) percent of the relative ratio(s) are in the range of, but not limited to ninety (90) and one hundred and ten (110). The average value of the relative difference(s) which are in the range of ninety (90) and one hundred and ten (110) may be calculated. The average value of the relative difference(s) may be represented as D. The average value may be corrected, as in step 210. The average value may be corrected by applying a formula:

$$η = \frac{M ( n ) - M ( 1 )}{D} + 1$$

where,
M(n) is an element in the index value(s) at n^{th} position;
M(1) is an initial value in the index value(s);
D is the average value; and
η is the corrected average value.

The corrected average value is further corrected by applying an algorithm:

IF η≦0

THEN η=0

ELSE IF η>n

THEN η=n

END IF

The further corrected average value may be assigned to an initial search index of binary search algorithm, as in step 212. A search element in the index values(s) loaded to the cache memory may be searched to obtain address associated with the searched index value, as in step 214. The search element may be a value to be searched in a data table.

In the present embodiment, the method may display a result of the search on a user interface. The result may be one of a null value and a data row. The data row may be one or more data row(s) associated with the data table. In another embodiment a result may be provided as input to one or more queries.

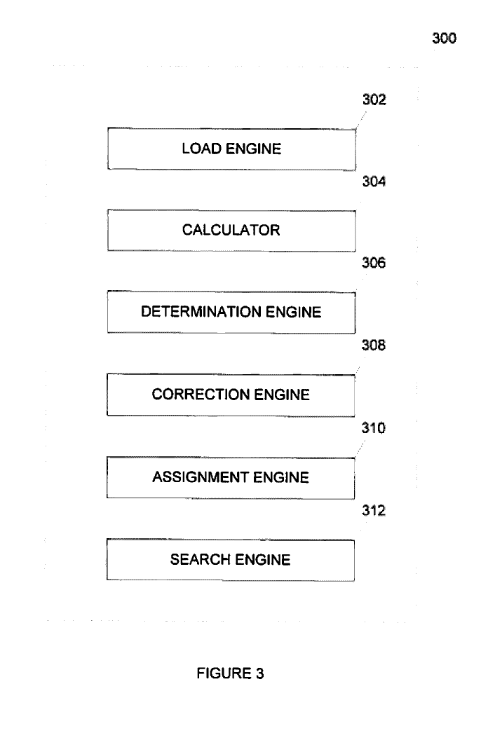

FIG. 3 is a block diagram, illustrating a system for searching in a binary tree through modified binary search, according to one or more embodiments. The system for searching in a binary tree through modified binary search may include a load engine 302, a calculator 304, a determination engine 306, a correction engine 308, an assignment engine 310 and a search engine 312. The load engine 302 may be configured to load index value(s) from a binary tree to a cache memory. The index value(s) may be associated with order property and/or approximate relative position property. The index value(s) may have order property if an element in a set of the index value(s) is greater than a preceding element and lesser than a succeeding element. The approximate relative position property may be a relative position assigned an element of the index value(s). The approximate relative position property may be with reference to neighbor element(s) in a sorted sequence of the index value(s). For example, consider a sequence 1, 2 and 3. Element 2 of the sequence may occur at second position with respect to 1 and 3. The element 2 is greater than one 1 and lesser than 3, then the element 2 will the order property. Similarly, element 3 of the sequence may occur at third position. The calculator 304 may be configured to calculate a relative difference(s) between the index value(s). The relative difference(s) may be calculated by applying formulae in the Table 1.

Consider η to be position of index value(s) loaded to the cache memory. Consider d to be the relative difference(s). The relative difference(s) may be calculated for element(s) of the index value(s) by applying a formula:

$${d}_{n - 1} = \frac{M ( n ) - M ( 1 )}{ n - 1}$$

where,
n is the position of the index value(s) loaded to the cache memory;
M(n) is an element in the index value(s);
M(1) is an initial element in the index value(s); and
dₙ₋₁ is the relative difference(s) of nth element of the index value(s).
The calculator 304 may be further configured to calculate a relative ratio(s) of the relative difference(s). The relative ratio(s) r may be calculated by applying a formula:

$${r}_{n - 2} = ( \frac{{d}_{n - 1}}{{d}_{n - 2}} ) \times 100$$

where,
rₙ₋₂ is the relative ratio of the relative difference(s); and
dₙ₋₁ and dₙ₋₂ are the relative difference(s) n−1^{th} and n−2^{th} element of the index value(s) respectively.

In an example embodiment, M(n) is an element in the index value at the n^{th} position. In another example embodiment, M(n) may be an element to be searched in the index value(s).

The determination engine 306 may be configured to determine an average value of the relative difference(s). The average value of the relative difference(s) may be determined if value(s) of at least eighty (80) percent of the relative ratio(s) are in the range of, but not limited to ninety (90) and one hundred and ten (110). The average value of the relative difference(s) which are in the range of ninety (90) and one hundred and ten (110) may be determined. The average value of the relative difference(s) may be represented as D. The correction engine 308 may be configured to correct the average value. The average value may be corrected by applying a formula:

$$η = \frac{M ( n ) - M ( 1 )}{D} + 1$$

where,
M(n) is an element in the index value(s) at nth position;
M(1) is an initial value in the index value(s);
D is the average value; and
η is the corrected average value.

The corrected average value may be further corrected by applying an algorithm:

IF η≦0

THEN η=0

ELSE IF η>n

THEN η=n

END IF

The assignment engine 310 may be configured to assign, the further corrected average value to an initial search index of binary search algorithm. The search engine 312 may be configured to search element in the index value(s) loaded to the cache memory may be searched to obtain address associated with the searched index value. The search element may be a value to be searched in a data table.

In the present embodiment, the system may display a result of the search on a user interface. The result may be one of a null value and a data row. The data row may be one or more data row(s) associated with the data table. In another embodiment a result may be provided as input to one or more queries.

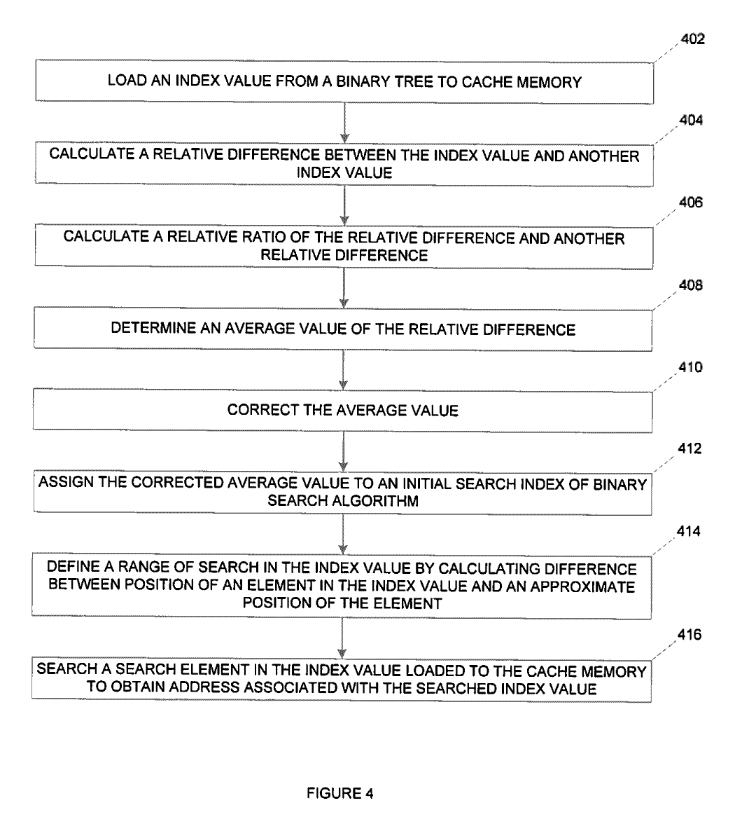

FIG. 4 is a process flow diagram, illustrating a method for searching in a binary tree through modified binary search, according to one or more embodiments. The method includes loading, index value(s) from a binary tree to a cache memory, as in step 402. The index value(s) may be associated with order property and/or approximate relative position property. The index value(s) may have order property if an element in a set of the index value(s) is greater than a preceding element and lesser than a succeeding element. The approximate relative position property may be a relative position assigned to an element of the index value(s). The approximate relative position property may be with reference to neighbor element(s) in a sorted sequence of the index value(s). For example, consider a sequence 1, 2 and 3. Element 2 of the sequence may occur at second position with respect to 1 and 3 The element 2 is greater than one 1 and lesser than 3, then the element 2 will the order property. Similarly, element 3 of the sequence may occur at third position. A relative difference(s) between the index value(s) may be calculated, as in step 404. The relative difference(s) may be calculated by applying formulae in the Table 1.

Consider n to be position of the index value(s) loaded to the cache memory. Consider d to be the relative difference(s). The relative difference(s) may be calculated for all values of n by applying a formula:

$${d}_{n - 1} = \frac{M ( n ) - M ( 1 )}{n - 1}$$

where,
n is the position of the index value(s) loaded to the cache memory;
M(n) is an element in the index value(s) at the nth position;
M(1) is an initial element in the index value(s); and
dₙ₋₁ is the relative difference(s) of n^{th} element of the index value(s).
A relative ratio(s) of the relative difference(s) may be calculated, as in step 406. The relative ratio(s) r may be calculated by applying a formula:

$${r}_{n - 2} = ( \frac{{d}_{n - 1}}{{d}_{n - 2}} ) \times 100$$

where,
rₙ₋₂ is the relative ratio of the relative difference(s); and
dₙ₋₁ and dₙ₋₂ are the relative difference(s) of n−1^{th} and n−2^{th} respectively

In an example embodiment, M(n) is an element in the index value at the nth position. In another example embodiment, M(n) may be an element to be searched in the index value(s).

An average value of the relative difference(s) may be determined, as in step 408. The average value of the relative difference(s) may be determined if value(s) of at least eighty (80) percent of the relative ratio(s) are in the range of, but not limited to ninety (90) and one hundred and ten (110). The average value of the relative difference(s) which are in the range of ninety (90) and one hundred and ten (110) may be determined. The average value of the relative difference(s) may be represented as D. The average value may be corrected, as in step 410. The average value may be corrected by applying a formula:

$$η = \frac{M ( n ) - M ( 1 )}{D} + 1$$

where,
M(n) is an element in the index value(s) at nth position;
M(1) is an initial value in the index value(s);
D is the average value; and
η is the corrected average value.

The corrected average value may be further corrected by applying an algorithm.

IF η≦0

THEN η=0

ELSE IF η>n

THEN η=n

END IF

The further corrected average value may be assigned to an initial search index of binary search algorithm, as in step 412. A range of binary search in the index value(s) may be defined by calculating difference between position of an element in the index value(s) and an approximate position of the element, as in step 414. The approximate position of the element may be calculated by a formula:

$${η}_{n} = \frac{M ( n ) - M ( 1 )}{D} + 1$$

where,
n is the position of an element in the index value(s);
nₙ is the approximate position of the nth element in the index value(s);
M(n)is the element in the index value(s);
M(1)is a first element in the index value(s); and
D is the average value of the relative difference(s).

The approximate position may be calculated to all element(s) in the index value(s) as represented in the Table 2. As represented in the Table 2, value(s) of δ may be calculated to define range of the binary search. From the Table 2, minimum and maximum value of δ may be determined. The minimum value of δ may be represented as δmin and maximum value of δ may be represented as δmax. A value, bandwidth of randomness may be determined by applying a formula:

β=|δmin|+|δmax|

The bandwidth of randomness may be defined as the maximum span of sequence to be searched in the index value(s). If the bandwidth of randomness is higher, then the randomness of the sequence may be higher. Consider N to be a length of the index value(s). If a value obtained by dividing log₂ N and log₂β is greater than or equal to two (2), a search element may be searched based on the corrected average value in the index value(s) to obtain address associated with the searched index value, as in step 416. The step 416, may be performed by assigning η−|δ min| to lower limit and η+|δ max| to higher limit of the binary search algorithm. The search element may be a value to be searched in a data table.

In the present embodiment, the method may display a result of binary search on a user interface. The result may be one of a null value and a data row. The data row may be one or more data row(s) associated with the data table. In another embodiment a result may be provided as input to one or more queries.

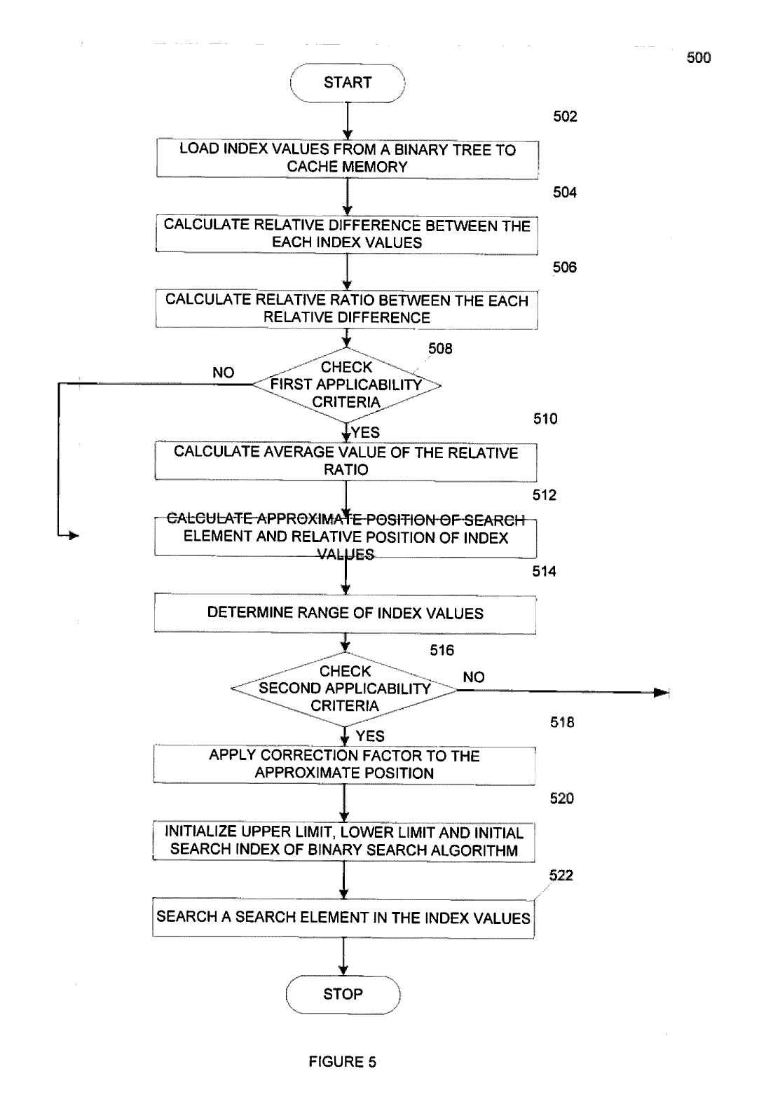

FIG. 5 is a flow chart, illustrating steps to search binary tree with modified binary search algorithm, according to one or more embodiments. The steps include loading, index value(s) from a binary tree to a cache memory, as in step 502. A relative difference(s) between the index value(s) may be calculated, as in step 504. The relative difference(s) may be calculated by applying formulae in the Table 1.

Consider n to be position of the index value(s) loaded to the cache memory. Consider d to be the relative difference(s). The relative difference(s) may be calculated for element(s) of the index value(s) by applying a formula:

$${d}_{n - 1} = \frac{M ( n ) - M ( 1 )}{n - 1}$$

where,
n is the position of the index value(s) loaded to the cache memory;
M(n) is an element in the index value(s) at the nth position;
M(1) is an initial element in the index value(s); and
dₙ₋₁ is the relative difference(s) of n^{th} element in the index value(s).
A relative ratio(s) of the relative difference(s) may be calculated, as in step 506. The relative ratio(s) r may be calculated by applying a formula:

$${r}_{n - 2} = ( \frac{{d}_{n - 1}}{{d}_{n - 2}} ) \times 100$$

where,
rₙ₋₂ is the relative ratio of the relative difference(s); and
dₙ₋₁ and dₙ₋₂ are the relative difference(s) of n−1^{th} and n−2^{th} element respectively.

In an example embodiment, M(n) is an element in the index value at the n^{th} position. In another example embodiment, M(n) may be an element to be searched in the index value(s).

A first applicability criteria may be checked based on the relative ratio(s), as in step 508. The first applicability criteria may be, values of at least eighty (80) percent of a set of the relative ratio(s) are in the range of ninety and one hundred and ten. The average value of the relative difference(s) which are in the range of ninety (90) and one hundred and ten (110) may be calculated, as in step 510, if the first applicability criteria of the step 508 is satisfied. An approximate position of a search element and a relative position of the index value(s) may be calculated, as in step 512. The approximate position of the search element may be calculated based on formula:

η=(M(n)−M(1))/D+1

where,
M(n) is an element in the index value(s) at n^{th} position;
M(1) is an initial value in the index value(s);
D is the average value; and
η is the approximate position of the search element.
The approximate position of the search element obtained by applying the above formula may be a corrected average value.

The relative position of the index value(s) may be calculated, based on formula listed in the Table 2. Based on the relative position of the index value(s), a range of index value(s) may be determined, as in step 514. The range of values may be called as bandwidth of randomness. The bandwidth of randomness may be defined as the maximum span of sequence to be searched in the index value(s). If the bandwidth of randomness is higher, then the randomness of the sequence may be higher. The bandwidth of randomness may be represented as β. From the Table 2, minimum and maximum value of β may be calculated. The minimum value of δ may be represented as δmin and maximum value of δ may be represented as δmax. The bandwidth of randomness may be calculated as:

β=|δmin|+|δmax|

A second applicability criteria may be checked based on the bandwidth of randomness, as in step 516. Consider N to be the length of the index value(s). The second applicability criteria may be, to determine a value obtained by dividing log₂N and log₂β is greater than or equal to two (2). The second applicability criteria may be represent as:

$$\frac{{log}_{2} N}{{log}_{2} β} \geq 2$$

where,
N is length of the index value(s) loaded to the cache memory.

A correction factor may be applied to the approximate position of the search element as in step 518, if the second applicability criteria of the step 516 is satisfied. The correction factor may be applied by applying an algorithm:

IF η≦0

THEN η=0

ELSE IF η>n

THEN η=n

END IF

After correcting the approximate position of the search element, an initial search element of a binary search algorithm may be initialized with the corrected approximate position of the search element, as in step 520. A lower limit and a higher limit of the binary search algorithm may be initialized η−|δmin| and η+|δmax| respectively, as in the step 520. After the initialization in the step 520, the search element may be searched by applying the binary search algorithm, as in step 522.

In the present embodiment, the method may display a result of binary search on a user interface. The result may be one of a null value and a data row. The data row may be one or more data row(s) associated with the data table. In another embodiment a result may be provided as input to one or more queries.

In an example embodiment, consider n to be position of index value(s) loaded to a cache memory, M(n) to be the index value(s). The index value(s) may be as given in Table 3.

TABLE 3

| n | M(n) | |
|---|---|---|
| 1 | 1 | M(1) |
| 2 | 2 | M(2) |
| 3 | 3 | M(3) |
| 4 | 4 | M(4) |
| 5 | 5 | M(5) |
| 6 | 7 | M(6) |
| 7 | 8 | M(7) |
| 8 | 10 | M(8) |

A relative difference(s) of the index value(s), represented as d may be calculated as shown in Table 4, based on the formula in the Table 2. A relative ratio(s) of the relative difference, represented as r may be calculated as shown in the Table 4.

TABLE 4

| n | M(n) | ${d}_{n - 1} = \frac{M ( n ) - M ( 1 )}{n - 1}$ | ${r}_{n - 2} = ( \frac{{d}_{n - 1}}{{d}_{n - 2}} ) \times 100$ | ${η}_{n} = \frac{M ( n ) - M ( 1 )}{D} + 1$ | δₙ = nₙ − ηₙ |
|---|---|---|---|---|---|
| 1 | 1 | N/A | N/A | 1 | 0 |
| 2 | 2 | d1 = 1.00 | N/A | 2 | 0 |
| 3 | 3 | d2 = 1.00 | r1 = 100.00% | 3 | 0 |
| 4 | 4 | d3 = 1.00 | r2 = 100.00% | 4 | 0 |
| 5 | 5 | d4 = 1.00 | r3 = 100.00% | 5 | 0 |
| 6 | 7 | d5 = 1.20 | r4 = 83.33% | 7 | −1 |
| 7 | 9 | d6 = 1.17 | r5 = 102.86% | 8 | −1 |
| 8 | 10 | d7 = 1.29 | r6 = 90.74% | 10 | −2 |

A first applicability criteria may be checked based on value of r. The value of r₁, r₂, r₅ and r₆ is present in range of ninety (90) and one hundred and ten (110). Values of M (n) may be considered if the value of the relative ratio(s) are in the range of ninety (90) and one hundred and ten (110) to calculate an average value. The average value may be represented as D, and the value of D in the present example embodiment is one (1). A difference(s) between position of an element(s) of the index values(s) and an approximate position of the element(s) may be calculated, as shown in the Table 4. An approximate position of a search element may also be calculated. The search element may be a value to be searched in data table and/or in the index value(s). The position of the element(s) may be represented as nₙ. The approximate position of the element(s) may be represented as nₙ. Consider δₙ to be the difference between the position of the element and the approximate position of the element. Based on value(s) of the δₙ, a bandwidth of randomness, represented as β may be determined. A value of |δmin| and |δmax| may be determined from the Table 4. In the present example embodiment, the bandwidth of randomness may be two (2). A second applicability criteria may be checked. The second applicability criteria may be satisfied since value obtained by dividing log₂8 and log₂2 is three (3). A correction factor may be applied on the approximate position of the search element. A lower limit and a higher limit of the binary search algorithm may be initialized with η−|δmin| and η+|δmax| respectively. An initial search index of the binary search algorithm may be initialized with the approximate position of the search element. The search element may be searched by applying the binary search algorithm.

Consider seven (7) to be the search element. The search element to be searched in the index value(s) of the Table 3. The approximate position may be calculates as below:

$$η = \frac{M ( n ) - M ( 1 )}{D} + 1$$

$$η = \frac{7 - 1}{1} + 1$$

$$η = 7$$

The lower limit and the higher limit may be seven (7) and nine (9) as shown below:

η−|δmin|=7

η+|δmax|=9

In first iteration of the binary search algorithm, M(7) is not equal to the search element seven (7). Based on logic of the binary search algorithm, the upper limit may be modified. Another index value of the algorithm, termed as mid-point of the lower limit and the upper limit may be determined, as per the binary search algorithm. In second iteration of the binary search algorithm, M(8) is equal to the search element seven (7). Searching may be stopped after the search element is found.

Advantage of disclosed method and/or system for searching in a binary tree through modified binary search is as described here in. The method and/or the system may work faster compared to existing binary search algorithm. The bandwidth of randomness, β may define the speed of search compared to the existing binary search algorithm.

In worst case scenario, η value may be equal N/2. The N may the size of the index value(s). In the worst case scenario, performance of search may be represented as log(N/2).

In best case scenario, sequence of the index values may be in absolute arithmetic progression. In the best case scenario, D=d and η=n. For smaller size of the index value(s), the graph of n VS η may be near to linear. For larger size of the index value(s), the graph of n VS η may be linear.

In one or more embodiments, a method of searching in a binary tree stored in a distributed database through modified binary search may include multiple steps. The method may involve loading one or more index values from a binary tree stored in the distributed database to a cache memory. A relative difference between one index value and another index value may be calculated. A relative ratio of one relative difference and another relative difference may be calculated and an average value of the one or more relative differences is determined. The determined average value may be corrected based on a correction factor. The corrected average value may be assigned to an initial search index of binary search algorithm. A search element in the one or more index values loaded to the cache memory may be searched to obtain one or more addresses associated with the searched index value.

Although the present embodiments have been described with reference to specific example embodiments, it will be evident that various modifications and changes may be made to these embodiments without departing from the broader spirit and scope of the various embodiments. For example, the various devices and modules described herein may be enabled and operated using hardware circuitry, firmware, software or any combination of hardware, firmware, and software (e.g., embodied in a machine readable medium). For example, the various electrical structure and methods may be embodied using transistors, logic gates, and electrical circuits (e.g., application specific integrated (ASIC) circuitry and/or in Digital Signal Processor (DSP) circuitry).

In addition, it will be appreciated that the various operations, processes, and methods disclosed herein may be embodied in a machine-readable medium and/or a machine accessible medium compatible with a data processing system (e.g., a computer devices), and may be performed in any order (e.g., including using means for achieving the various operations). Various operations discussed above may be tangibly embodied on a medium readable through the retail portal to perform functions through operations on input and generation of output. These input and output operations may be performed by a processor. The medium readable through the retail portal may be, for example, a memory, a transportable medium such as a CD, a DVD, a Blu-ray™ disc, a floppy disk, or a diskette. A computer program embodying the aspects of the exemplary embodiments may be loaded onto the retail portal. The computer program is not limited to specific embodiments discussed above, and may, for example, be implemented in an operating system, an application program, a foreground or background process, a driver, a network stack or any combination thereof. The computer program may be executed on a single computer processor or multiple computer processors.

Accordingly, the specification and drawings are to be regarded in an illustrative rather than a restrictive sense.

What is claimed is:

1. A computer implemented method for searching in a distributed database comprising:
loading (402), through a processor (102) associated with a computer network, at least one index value from the binary tree stored in the distributed database to a cache memory;
calculating (404), through a processor (102), a relative difference between the at least one index value and another index value;
calculating (406), through a processor (102) ,a relative ratio of the at least one relative difference and at least another relative difference;
determining (408), through a processor (102), an average value of the at least one relative difference;
correcting (410), through a processor (102), the average value;
assigning (412), through a processor, the corrected average value to an initial search index of binary search algorithm;
defining (414), through a processor (102), a range of search in the at least one index value, by calculating difference between position of an element in the at least one index value and an approximate position of the element; and
searching (416), through a processor (102), a search element based on the corrected average value in the at least one index value loaded to the cache memory to obtain address associated with the searched index value.

2. The method of claim 1, wherein the approximate position of the element is calculated based on the element, initial value of the at least one index value and the average value.

3. The method of claim 1, further comprises, displaying a result of the search.

4. The method of claim 1, further comprises, providing the result as input to one or more queries.

5. The method of claim 1, wherein the search element is a value to be searched in a data table.

6. The method of claim 3, wherein the result is one of a null value and a data row.

7. The method of claim 6, wherein the data row is at least one row associated with the data table.

8. A system (300) for searching in a distributed database comprising:
a computer network (400);
a database server associated with the computer network (400);
one or more processors (102) communicatively coupled to the database server and the distributed database through the computer network (400); and
one or more memory units (104 and 106) operatively coupled to at least one of the one or more processors (102) and having instructions (124) stored thereon that, when executed by at least one of the one or more processors (102), cause at least one of the one or more processors (102) to:
load (302) at least one index value from the binary tree stored in the distributed database to a cache memory;
calculate (304):
a relative difference between the at least one index value and another index value;
a relative ratio of the at least one relative difference and at least another relative difference;
determine (306) an average value of the at least one relative ratio;
correct (308) the average value;
assign (310) the corrected average value to an initial search index of binary search algorithm; and
search (312) a search element in the at least one index value loaded to the cache memory to obtain address associated with the searched index value.

9. The system (300) of claim 8, further comprises instructions to:
display through a user interface a result of the search.

10. The system (300) of claim 8, further comprises instructions to:
provide the result as input to one or more queries.

11. The system (300) of claim 8, wherein the search element is a value to be searched in a data table.

12. The system (300) of claim 9, wherein the result is one of a null value and a data row.

13. The system (300) of claim 12, wherein the data row is at least one row associated with the data table.
